(19) United States
(12) Patent Application Publication
(10) Pub. No.: US 2018/0213830 A1
(43) Pub. Date: Aug. 2, 2018

(54) OIL AND FAT COMPOSITION FOR RICE COOKING AND METHOD FOR MANUFACTURING BOILED RICE USING THE SAME

(71) Applicant: J-OIL MILLS, INC., Tokyo (JP)

(72) Inventors: Atsushi Ekyou, Tokyo (JP); Jun Imagi, Tokyo (JP)

(21) Appl. No.: 15/871,378

(22) Filed: Jan. 15, 2018

(30) Foreign Application Priority Data
Feb. 2, 2017 (JP) 2017-017194

(51) Int. Cl. A23L 7/196; A23D 9/013; A23D 9/06; A23L 5/10

(52) U.S. Cl. CPC A23L 7/1965; A23D 9/013; A23V 2002/00; A23L 5/10; A23D 9/06

(57) ABSTRACT

[Problem]

It is an object to provide an oil and fat composition for rice cooking, which can suppress hardening of boiled rice after refrigeration and furthermore can improve an appearance of the boiled rice after refrigeration, by adding the composition when cooking the rice.

[Solution]

The oil and fat composition for rice cooking comprises edible oil and fat, 0.1% to 3% by mass of lecithin. 0.002% to 1% by mass of ascorbic acid analog compound and 0.01% to 3% by mass of polyglycerol condensed ricinoleate.

### TECHNICAL FIELD

The present invention relates to an oil and fat composition for rice cooking, and a method for manufacturing boiled rice using the same.

### BACKGROUND ART

For conventional oil and fat compositions for rice cooking, for example: an oil and fat composition prepared by blending an oil and fat with a glyceride citrate (Patent Document 1); an oil and fat composition prepared by blending an emulsifier comprising at least one selected from a monoglyceride, a monoglyceride citrate, a monoglyceride diacetyl tartrate, a sucrose fatty acid ester, and a polyglyceride having oleic acid in its main constituent fatty acid with a polyglycerol condensed ricinoleate (Patent Document 2); and an oil and fat composition in which a monoglyceride, polyglycerol condensed ricinoleate, and lecithin in combination (Patent Document 3) are used in combination, have been proposed. However, none of the patent documents discloses a problem of suppressing hardening of boiled rice after refrigeration.

### PRIOR ART DOCUMENTS

### Patent Documents

Patent Document 1: JP H07-298843 A

Patent Document 2: JP H03-175940 A

Patent Document 3: JP H07-274859 A

### SUMMARY OF INVENTION

### Problem to be Solved

It is an object of the present invention to provide an oil and fat composition for rice cooking, which can suppress hardening of boiled rice after refrigeration by adding the composition when cooking raw rice, and furthermore to provide an oil and fat composition for rice cooking, which can improve an appearance of the boiled rice after refrigeration.

### Solution to Problem

As a result of intensive studies to solve the above-mentioned problems, the present inventors found that hardening of a boiled rice after refrigeration could be suppressed and further an appearance of the boiled rice after refrigeration could be improved by adding a predetermined amount of oil and fat composition comprising edible oil and fat, a lecithin, an ascorbic acid analog compound and a polyglycerol condensed ricinoleate during rice cooking, thereby completing the present invention.

That is, the present invention is an oil and fat composition for rice cooking, which comprises edible oil and fat, 0.1% to 3% by mass of lecithin, 0.002% to 1% by mass of ascorbic acid analog compound and 0.01% to 3% by mass of polyglycerol condensed ricinoleate.

Preferably, the ascorbic acid analog compound is an ascorbic acid ester.

Preferably, a content of acetone insoluble matters in the lecithin is 50° % to 100% by mass.

In addition, preferably, the edible oil and fat contains one or two or more kinds of oil selected from rapeseed oil, rice oil and soybean oil.

Preferably, the total amount of the rapeseed oil, the rice oil and the soybean oil in the edible oil and fat is 80% to 100% by mass.

The present invention is also a method for manufacturing boiled rice, which comprises adding, relative to 100 parts by mass of raw rice, 0.1 parts to 6.5 parts by mass of an oil and fat composition comprising edible oil and fat, 0.1% to 3% by mass of lecithin, 0.002% to 1% by mass of ascorbic acid analog compound and 0.01% to 3% by mass of polyglycerol condensed ricinoleate in order to cook rice.

Also, the present invention is a method for suppressing hardening of boiled rice after refrigeration, which comprises adding, relative to 100 parts by mass of raw rice, 0.1 parts to 6.5 parts by mass of an oil and fat composition comprising edible oil and fat, 0.1% to 3% by mass of lecithin, 0.002% to 1% by mass of the ascorbic acid analog compound and 0.01% to 3% by mass of polyglycerol condensed ricinoleate, when cooking the raw rice. Herein, the refrigeration temperature is greater than 0° C. and not greater than 10° C.

Also, the present invention is a method for improving an appearance of boiled rice after refrigeration, which comprises adding, relative to 100 parts by mass of raw rice, 0.1 parts to 6.5 parts by mass of an oil and fat composition comprising edible oil and fat, 0.1% to 3% by mass of lecithin, 0.002% to 1% by mass of ascorbic acid analog compound and 0.3% to 3% by mass of polyglycerol condensed ricinoleate, when cooking the raw rice. Herein, the appearance means, inter alia, gloss.

### Effects of Invention

By adding the oil and fat composition for rice cooking comprising a predetermined amount of edible oil and fat, lecithin, ascorbic acid analog compound and polyglycerol condensed ricinoleate when cooking rice, hardening of the boiled rice after refrigeration can be suppressed. Furthermore, the appearance of the boiled rice, inter alia, gloss can be improved.

### DESCRIPTION OF EMBODIMENTS

The edible oils and fats used in the present invention include, but are not particularly limited to, e.g. various vegetable oils and fats and animal oils and fats such as palm oil, palm kernel oil, coconut oil, corn oil, cottonseed oil, soybean oil, rapeseed oil, rice oil (also referred to as rice bran oil), sunflower oil, safflower oil, olive oil, peanut oil, kapok oil, sesame oil, evening primrose oil, cocoa butter, shea butter, sal butter, beef tallow milk fat, lard, fish oil and whale oil, as well as processed oils and fats subjected to one or two or more treatments selected from hydrogenation, fractionation and transesterification. In the present invention, one or two or more kinds selected from them can be used, but preferably, one or two or more kinds selected from rapeseed oil, soybean oil, rice oil, corn oil, cottonseed oil, high-oleic sunflower oil and palm fractionated oil are used. More preferably, the edible oils and fats contain one or two or more kinds selected from rapeseed oil, rice oil, soybean oil, corn oil and palm fractionated oil, even more preferably, the edible oils and fats contain one or two or more kinds selected from rapeseed oil, rice oil, and soybean oil. In addition, preferably the total amount of rapeseed oil, rice oil and soybean oil in the edible oils and fats is 80% to 100% by mass, and more preferably the total amount of rapeseed oil and rice oil is 80% to 100% by mass.

The content of the edible oils and fats contained in the oil and fat composition of the present invention is preferably not less than 80% by mass, more preferably not less than 90% by mass, and even more preferably not less than 94% by mass. Although there is no specific upper limit for the content of the edible oils and fats, the edible oils and fats are contained so that the contents of lecithin, the ascorbic acid analog compound, polyglycerol condensed ricinoleate and the edible oils and fats is not more than 100% by mass. The water content in the oil and fat composition for rice cooking of the present invention is not more than 1% by mass, for example.

The lecithin used in the present invention is a general term for lecithin idiomatically used in fields of foods or food additives. A lecithin composed of a mixture mainly comprising phospholipids, such as a pasty lecithin prepared from crude raw materials such as byproducts in purifying vegetable oils from soybean, rapeseed, corn, sunflower, palm, peanut and the like (e.g. hydrates generated in a degumming process) and egg yolk; a fractionation lecithin obtained by fractionating this crude raw material by a solvent; and an enzyme-degradable lecithin obtained by enzymatically treating this crude raw material, can be used. Although the lecithin is not particularly limited in the present invention, the pasty lecithin is preferable. Also, a lecithin derived from soybean is preferable.

The content of the lecithin in the oil and fat composition for rice cooking of the present invention is 0.1% to 3% by mass, preferably 0.2% to 3% by mass, more preferably 0.3% to 2% by mass, even more preferably 0.4% to 1.5% by mass, and further preferably 0.5% to 1% by mass.

The content of acetone insoluble matters in the lecithin is preferably 50% to 100% by mass, more preferably 50% to 80% by mass, and even more preferably 55% to 70% by mass.

The content of the acetone insoluble matters in the lecithin can be calculated from the content of acetone soluble matters measured according to Japan's Specifications and Standards for Food Additives Handbook (Fifth Edition, p. D-1054). Specifically, it is obtained by the following method.

About 2 g of lecithin is precisely weighed in a 50 mL graduated stoppered centrifuge tube to obtain mass (A). 3 mL of petroleum ether is added into the centrifuge tube to dissolve the lecithin, 15 mL of acetone is added and stirred thoroughly, and then left in ice water for 15 minutes. To this, acetone previously cooled to 0 to 5° C. is added so that the volume is 50 mL, stirred thoroughly, left in ice water for 15 minutes. Then the centrifuge tube is centrifuged at about 3000 rpm for 10 minutes, and the upper layer liquid is collected in a flask. Furthermore, acetone at 0 to 5° C. is added to the precipitate in the centrifuge tube so that the volume is 50 mL, stirred thoroughly while cooling in ice water, and then centrifuged in the same way. The upper layer liquid is combined with the preceding flask, distilled in a water bath, and the residue is dried at 105° C. for 1 hour, and its mass (B) is precisely weighed.

According to this measurement, if the acetone soluble matter content in lecithin is obtained, the acetone insoluble matter content is calculated by the following equation.

Acetone insoluble matter (mass %)=(1−B/A)×100

The polyglycerol condensed ricinoleate used in the present invention can be obtained e.g. by esterification reaction of a condensed ricinoleic acid derived from castor oil as a raw material with a polyglycerol, and is abbreviated as PGPR in some cases. In the present invention, a glycerol polymerization degree in the polyglycerol condensed ricinoleate is not particularly limited.

From the viewpoint of suppressing the hardening of the boiled rice after refrigeration, the content of the polyglycerol condensed ricinoleate in the oil and fat composition for rice cooking is 0.01% to 3% by mass, preferably 0.05% to 1.5% by mass, more preferably 0.1% to 1.0% by mass, and even more preferably 0.3% to 0.7% by mass.

From the viewpoint of improving the appearance of the cooked rice after refrigeration, the content of the polyglycerol condensed ricinoleate in the oil and fat composition for rice cooking is preferably 0.3% to 3% by mass, more preferably 0.4% to 1.5% by mass, even more preferably 0.4% to 1.0% by mass, and further preferably 0.5% to 0.75% by mass.

The ascorbic acid analog compound used in the present invention means an ascorbic acid, an ascorbate and an ascorbic acid ester. The ascorbic acid analogous compound is preferably one or two or more kinds selected from an ascorbic acid and an ascorbic acid ester, more preferably an ascorbic acid ester, even more preferably an ascorbic acid fatty acid ester, and further preferably an ascorbyl palmitate. The ascorbic acid fatty acid ester has good solubility in oils and fats and is easy to handle.

The content of the ascorbic acid analog compound in the oil and fat composition for rice cooking of the present invention is 0.002% to 1% by mass, preferably 0.003% to 0.8% by mass, more preferably 0.005% to 0.5% by mass, and further preferably 0.01% to 0.1% by mass.

In addition, boiled rice obtained by the manufacturing method of the present invention can be manufactured by using a conventional rice cooking method except that the oil and fat composition comprising the edible oil and fat, the lecithin, the ascorbic acid analog compound and the polyglycerol condensed ricinoleate is added. The amount of the added oil and fat composition relative to 100 parts by mass of raw rice is 0.1 parts to 6.5 parts by mass, preferably 0.3 parts to 4 parts by mass, and more preferably 0.8 parts to 3 parts by mass.

The type, production area, etc. of the raw rice used in the present invention are not particularly limited. For example, the rice lineages includes Japonica rice, Indica rice, Javanica rice, etc. When classified depending on starch ingredients, nonglutinous rice and glutinous rice are also included. When classified depending on kinds, ancient rice such as red rice and black rice is also included. Also, a rice polishing degree and processing of raw rice are not particularly limited. There are included not only white rice but also brown rice, rice with different rice polishing degrees such as half threshing rice, as well as sprouted brown rice, and processed rice such as pre-washed rice.

The boiled rice of the present invention means a matter obtained by boiling raw rice. Upon boiling, cereals such as barnyard millet, foxtail millet and wheat, as well as a rice analog which is formed into a shape of rice in such a way that nutrition functional components such as glucomannan, calcium and iron are kneaded thereinto may be contained. In that case, the masses of the cereals and the rice analog are included in the mass of the raw rice.

### EXAMPLES

Hereinafter, the present invention will be described in more detail with reference to examples and comparative examples. However, the following examples do not limit the present invention.

The followings were used upon the implementation.

Rapeseed oil (manufactured by J-OIL MILLS, Inc.)
Rice oil (manufactured by J-OIL MILLS, Inc.)
Soybean oil (manufactured by J-OIL MILLS, Inc.)
Lecithin (product name: lecithin CL (soybean-derived pasty lecithin, acetone insoluble matter content: 61% by mass), manufactured by J-OIL MILLS, Inc.)
Ascorbyl palmitate (product name: Ascorbyl Palmitate, manufactured by DSM N.V.) Polyglycerol condensed ricinoleate (hereinafter, abbreviated as PGPR) (product name: CR-200, Sakamoto Yakuhin kogyo Co., Ltd.)

### [Experimental Example 1] (Blending Amounts of PGPR and Ascorbyl Palmitate)

300 g of raw rice (Japonica rice, Sasa Nishiki) was washed, immersed in water at 25° C. for 90 minutes, transferred to a sieve, and drained. 540 g of water was added to this rice. Furthermore, 3.9 g of each oil and fat composition in Table 1 was added, and rice was boiled in a gas rice cooker (manufactured by Rinnai Corporation). The rice from the top to a depth of 1 cm was removed, the rice from the cooker bottom to a height of 1 cm or more was mildly mixed, and rice balls were made with a mold. The rice balls were cooled, then wrapped in a food wrap film, and stored under refrigeration (4° C.) for 2 days. Thereafter, the rice balls were brought back to room temperature. Three specialized panels conferred to evaluate food feeling and appearance according to the following evaluation criteria.

### <Food Feeling>

Double circle: very soft

Circle: soft

Triangle: somewhat soft

Cross: hard

### <Appearance>

Circle: glossy

Triangle: somewhat glossy

Cross: not glossy

TABLE 1

| | | Example | Example | Example | Example | Comparative | Comparative |
|---|---|---|---|---|---|---|---|
| | | 1-1 | 1-2 | 1-3 | 1-4 | Example 1-1 | Example 1-2 |
| oil and fat | rapeseed oil | 99.37 | 99.22 | 98.97 | 98.72 | 99.47 | 99.0 |
| composition | lecithin | 0.5 | 0.5 | 0.5 | 0.5 | 0.5 | 0.5 |
| | PGPR | 0.1 | 0.25 | 0.5 | 0.75 | — | 0.5 |
| | ascorbyl | 0.03 | 0.03 | 0.03 | 0.03 | 0.03 | — |
| | palmitate | | | | | | |

| | | | | | | |
|---|---|---|---|---|---|---|
| food feeling of boiled rice | ◯ | ◯ | ⊚ | ◯ | Δ | X |
| after refrigeration | | | | | | |
| appearance of boiled rice | Δ | Δ | ◯ | ◯ | Δ | Δ |
| after refrigeration | | | | | | |

*Unit in blending the oil and fat composition is mass % in each case.

The water content of all of the oil and fat compositions was not more than 1% by mass.

In the case that the oil and fat composition contained ascorbyl palmitate and the content of PGPR was within the range of 0.1% to 0.75% by mass, the food feeling of the boiled rice was good because it was soft even after refrigeration. Also, in the case that the content of PGPR was within the range of 0.5% to 0.75% by mass, the appearance of the boiled rice was good because it was glossy even after refrigeration. Particularly in the case that the content of PGPR was 0.5% by mass, the food feeling of the boiled rice was best and its appearance was also good. In the case that the composition contained no ascorbyl palmitate, the rice after refrigeration was hard and its appearance was somewhat glossy.

### [Experimental Example 2] (Blending Amount of Lecithin)

The food feeling and the appearance were evaluated by the same operation except that the fat and oil compositions in Table 2 were used instead of the fat and oil compositions in Table 1 in Experiment Example 1.

TABLE 2

| | | Example | Example | Example |
|---|---|---|---|---|
| | | 2-1 | 2-2 | 2-3 |
| oil and fat | rapeseed oil | 99.17 | 98.97 | 98.47 |
| composition | lecithin | 0.3 | 0.5 | 1.0 |
| | PGPR | 0.5 | 0.5 | 0.5 |
| | ascorbyl | 0.03 | 0.03 | 0.03 |
| | palmitate | | | |

| | | | |
|---|---|---|---|
| food feeling of boiled rice | ◯ | ⊚ | ⊚ |
| after refrigeration | | | |
| appearance of boiled rice | ◯ | ◯ | ◯ |
| after refrigeration | | | |

*Unit in blending the oil and fat composition is mass % in each case.

The water content of all of the oil and fat compositions was not more than 1% by mass.

In the case that the content of lecithin in the oil and fat composition was within the range of 0.3% to 1.0% by mass, the food feeling of the boiled rice was good because it was soft even after refrigeration, and its appearance was good because it was glossy. Particularly in the case that the content of lecithin in the oil and fat composition was 0.5% to 1% by mass, the food feeling of the boiled rice was very good.

### [Experimental Example 3] (Kinds of Edible Oil and Fat)

The food feeling and the appearance were evaluated by the same operation except that the fat and oil compositions in Table 3 were used instead of the fat and oil compositions in Table 1 in Experiment Example 1.

TABLE 3

| | | Example | Example | Example |
|---|---|---|---|---|
| | | 3-1 | 3-2 | 3-3 |
| oil and fat | rapeseed oil | 98.97 | — | — |
| composition | rice oil | — | 98.97 | — |
| | soybean oil | — | — | 98.97 |
| | lecithin | 0.5 | 0.5 | 0.5 |
| | PGPR | 0.5 | 0.5 | 0.5 |
| | ascorbyl | 0.03 | 0.03 | 0.03 |
| | palmitate | | | |

| | | | |
|---|---|---|---|
| food feeling of boiled rice | ⊚ | ⊚ | ◯ |
| after refrigeration | | | |
| appearance of boiled rice | ◯ | ◯ | ◯ |
| after refrigeration | | | |

*Unit in blending the oil and fat composition is mass % in each case.

The water content of all of the oil and fat compositions was not more than 1% by mass.

It was found that even when the edible oil and fat was changed from rapeseed oil to rice oil or soybean oil, the food feeling and the appearance of the rice after refrigeration were good as in the case of rapeseed oil.

1. An oil and fat composition for rice cooking, comprising edible oil and fat, 0.1% to 3% by mass of lecithin, 0.002% to 1% by mass of ascorbic acid analog compound and 0.01% to 3% by mass of polyglycerol condensed ricinoleate.

2. The oil and fat composition for rice cooking according to claim 1, wherein the ascorbic acid analog compound is an ascorbic acid ester.

3. The oil and fat composition for rice cooking according to claim 1, wherein a content of acetone insoluble matters in the lecithin is 50% to 100% by mass.

4. The oil and fat composition for rice cooking according to claim 1, wherein the edible oil and fat contains one or two or more kinds of oil selected from rapeseed oil, rice oil and soybean oil.

5. The oil and fat composition for rice cooking according to claim 4, wherein the total amount of the rapeseed oil, the rice oil and the soybean oil in the edible oil and fat is 80% to 100% by mass.

6. A method for manufacturing boiled rice, wherein the method comprises adding, relative to 100 parts by mass of raw rice, 0.1 parts to 6.5 parts by mass of an oil and fat composition comprising edible oil and fat, 0.1% to 3% by mass of lecithin, 0.002% to 1% by mass of ascorbic acid analog compound and 0.01% to 3% by mass of polyglycerol condensed ricinoleate in order to cook rice.

7. A method for suppressing hardening of boiled rice after refrigeration, wherein the method comprises adding, relative to 100 parts by mass of raw rice, 0.1 parts to 6.5 parts by mass of an oil and fat composition comprising edible oil and fat, 0.1% to 3% by mass of lecithin, 0.002% to 1% by mass of the ascorbic acid analog compound and 0.01% to 3% by mass of polyglycerol condensed ricinoleate, when cooking the raw rice.

8. A method for improving an appearance of boiled rice after refrigeration, wherein the method comprises adding, relative to 100 parts by mass of raw rice, 0.1 parts to 6.5 parts by mass of an oil and fat composition comprising edible oil and fat, 0.1% to 3% by mass of lecithin, 0.002% to 1% by mass of ascorbic acid analog compound and 0.3% to 3% by mass of polyglycerol condensed ricinoleate, when cooking the raw rice.
